(19) United States
(12) Patent Application Publication
(10) Pub. No.: US 2010/0086128 A1
(43) Pub. Date: Apr. 8, 2010

(54) Asymmetric encryption/decryption method

(76) Inventor: Chiou-Haun Lee, Taichung City (TW)

Correspondence Address: CHARLES E. BAXLEY, ESQUIRE, 90 JOHN STREET, SUITE 309, NEW YORK, NY, 10038, US

(21) Appl. No.: 12/287,372

(22) Filed: Oct. 8, 2008

(51) Int. Cl. H04L 9/30

(52) U.S. Cl. 380/30

(57) ABSTRACT

An asymmetric encryption/decryption method comprises the steps of: selecting a plaintext (M) and a modulus (n); selecting a public key (e) and a private key (d) from the modulus (n); and generating a ciphertext (C) by M×e mod n=C, or recovering the plaintext (M) by C×d mod n=M.

### BACKGROUND OF THE INVENTION

1. Field of the Invention

The present invention relates to an asymmetric encryption/decryption method including the steps of providing a plaintext (M) and a modulus (n); selecting a public key (e) and a private key (d) from the modulus (n); and generating a ciphertext (C) by M×e mod n=C or recovering the plaintext (M) by C×d mod n×M.

### DESCRIPTION OF THE RELATED ART

In a conventional asymmetric encryption/decryption method, two large prime numbers (p, q) are generally used to generate a modulus n=p×q, then φ(n)=(p−1)×(q−1) is used as a function modulus; and e×d mod φ(n)=1 is used to generate a public key (e) and a private key (d); a plaintext (M) is encrypted by M^{e} mod n=C to generate a ciphertext (C), or the plaintext (M) is recovered by C^{d} mod n=M.

The key point of security of the prior art emphasizes on the product of the two large prime numbers, and the values of the prime numbers cannot be cracked in a short time, and thus the security of pairing the public and private keys can be improved.

### SUMMARY OF THE INVENTION

It is a primary objective of the present invention to overcome the shortcomings of the conventional encryption/decryption method that adopts a raise to the power operation that raises the length of a value to a power in order to increase the cracking time, but such conventional method cannot reduce the processing time, if the high security of an event such as completing a transaction that involves a large amount of money or signing an important agreement is taken into consideration.

To achieve the foregoing objective, the present invention provides an asymmetric encryption/decryption method comprising the steps of: selecting a plaintext (M) and a modulus (n); selecting a public key (e) and a private key (d) from the modulus (n); and generating a ciphertext (C) by M×e mod n=C, or recovering the plaintext (M) by C×d mod n=M.

Compared with the prior art, the present invention has the following advantages:

1. Key: The key e×d mod φ(n)=1 the prior art is found by searching, but the key of the invention can be selected or generated from the modulus (n), and thus the key can be produced easily, and there are a large number of keys for your choice.

2. Operation: The prior art adopts a raise to the power operation of a value (self-multiplied for several times), but the present invention directly using a multiplication operation (multiplied for one time) and thus the processing is fast.

### BRIEF DESCRIPTION OF THE DRAWINGS

FIG. 1 is a flow chart of generating a public key and a private key in accordance with the present invention;

FIG. 2 is a flow chart of an encryption and a decryption in accordance with the present invention;

FIG. 3 is a plaintext picture in accordance with the present invention; and

FIG. 4 is a ciphertext picture in accordance with the present invention.

### DETAILED DESCRIPTION OF THE PREFERRED EMBODIMENTS

An asymmetric encryption/decryption method in accordance with the present invention comprises the following:

Symbol and Definition:

P: Prime number

N: Modulus of at least one product of prime numbers.

For example, (a) n=p×q p,q ε P

F: Function of public key and private key.

mⁱ×^{n+1/}ₘⁱ mod n=1, n+1 mod m=0, i,m>0

For example: (a) 2×n+ 1/2mod n=1

½ is the reciprocal of 2.

For example, (a) ½×2=1 (b) ½≡n+ 1/2

½ⁱ represents ½ⁱ mod n.

For example, (a) ½⁰=½^{(p-1)×(q-1)}=1 (b) ½^{(p-1)×(q-1)-1}=2

2ⁱ represents 2ⁱ mod n

For example, (a) 2⁰=2^{(p-1)×(q-1)}=1 (b) 2^{(p-1)×(q-1)-1}=½

Public Key and Private Key:

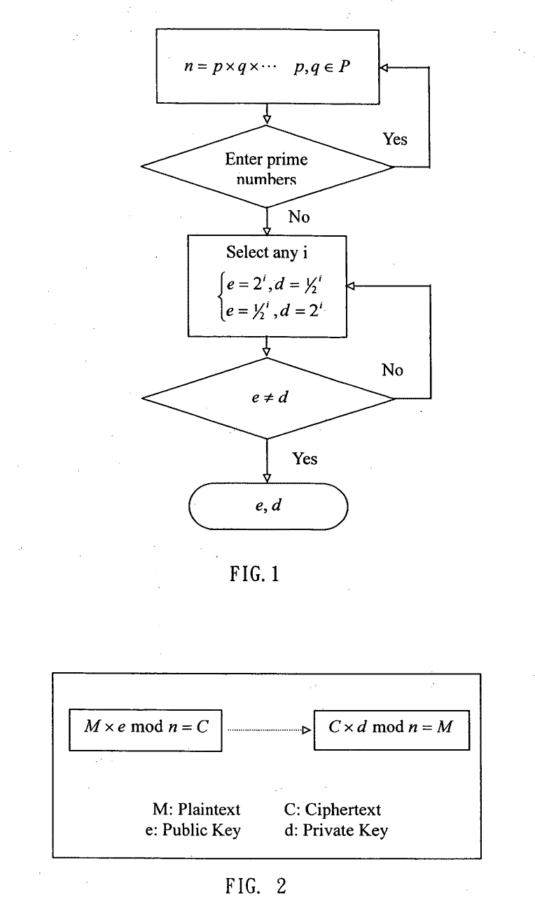

In the present invention, it is not necessary to take the function modulus φ(n) of the prior art into consideration. When the modulus (n) is generated, a public key (e) and a private key (d) can be selected. The method of the invention comprises the following steps and is shown in FIG. 1:

1. n=p×q×r× . . . p, q, r, . . . ε P;

2.

$$\{ \begin{matrix}e = {2}^{i} , d = 1 / {2}^{i} \\ e = 1 / {2}^{i} , d = {2}^{i} ;\end{matrix}$$

Encryption and Decryption:

Since e×d=1, therefore any plaintext is multiplied by e and then multiplied by d or multiplied by d and then multiplied by e to recover the plaintext. The encryption and decryption operations of the present invention as shown in FIG. 2 are described as follows:

1. M×e mod n=C

2. C×d mod n=M

Embodiments of Encryption and Decryption:

To make it easier for our examiner to understand the technical characteristics of the invention, we use a preferred embodiment focusing on public key and private key as well as encryption and decryption for the detailed description of the invention as follows.

Let p=45433, q=52691, and a linear 16-bit matrix be p=[1011000101111001], q=[1100110111010011]:

Public Key and Private Key:

n=p×q=[10001110101100000010101110111011]

½[01000111010110000001010111011110]

i=[11000001010000100011110011000111]

e=2ⁱ=[01010001110000100011010010010110]

d=½ⁱ=[10001101110111101010000001100110]

Encryption and Decryption:

M=[1011011101101011]<n

C=M×e mod n=[01011101010011110110100000101010]

M=C×d mod n=[1011011101101011]

### ADVANCED PREFERRED EMBODIMENT

from RSA-160:

$$\begin{matrix}p = 4542789285848139407168619064973883165613 \\ 7145778469793250959984709250004157335359 \\ q = 4738809060383201619663383230378895197326 \\ 8922921040957944741354648812028493909367 \\ n = p \times q \\ = 2152741102718889701896015201312825429257 \\ 7735888456759801704976767781331452188591 \\ 3567301105977349105960249790711158521430 \\ 2079314665202840140619946994927570407753\end{matrix}$$

Key Generation:

$$\begin{matrix}i = 1141447733381516457522111560056951161323 \\ 9983246697822741554965021196809923695765 \\ 1257988180808264183269473517075359372689 \\ 6626226946252650788121573206954270839453 \\ e = {2}^{i} \\ = 2043252770931019731835424536241805057954 \\ 9387636726678197587263747269515991209202 \\ 1188931968944038697865950346572655115685 \\ 1932909974146736938195025670844433810430 \\ d = 1 / {2}^{i} \\ = 3868505799287938389518502494003060692517 \\ 0144705852228942654788196629283318195373 \\ 9309657050648420028660647814081923279324 \\ 216822545917632852350813308010494734320\end{matrix}$$

Audio/Video Streaming

The public and private keys of the invention can be integrated with audio/video transmissions for processing an encryption or a decryption of a plurality of bits rapidly. A gray picture Lena is used for illustrating the procedure as follows:

1. Select n:530 bits, e:530 bits, d:527 bits.

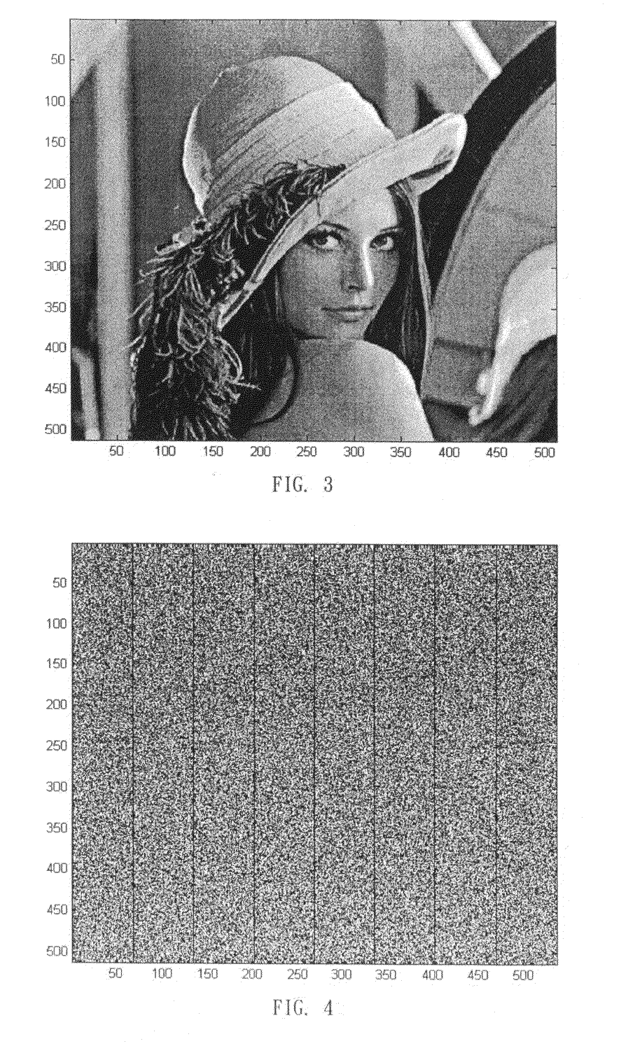

2. Select the Lena: 512×512 bytes, as shown in FIG. 3.

3. M: Keep reading 64 bytes for a stream plaintext.

4. C:M×e mod n: Convert the stream ciphertext into 67 bytes.

5. M:C×d mod n: Recover the stream plaintext back to 64 bytes.

6. Repeat Steps 3 to 5 for encrypting the picture as shown in FIG. 4.

Since a stream plaintext has a length of 64 bytes, which is smaller than the length of the private key, therefore it is impossible to find the private key by referencing the stream plaintext and the corresponding stream ciphertext.
Synchronization of Public and Private Keys

Since e×d =1 is used as the basic principle of encryption and decryption of the present invention, therefore (e×d)^{t}=1 is applied for setting each unit, such that e=e^{t}, d=d^{t}, and the values of the public and private keys are changed simultaneously.

if t=2:

$$\begin{matrix}e = {e}^{t} \\ = 1997258724189877716434312754738305804257 \\ 2425065519602884178853751189298841103690 \\ 1012205902070603611791917666901827030764 \\ 9667158028708013760501670494122913574461 \\ d = {d}^{t} \\ = 1016685379469916270687667972280497898519 \\ 8097821687106347892667897255959882891841 \\ 8284433927708416025308154614613800461897 \\ 6938931153533999866417848988458922150674\end{matrix}$$

From the embodiment, e=2ⁱ, d=½ⁱ, the value i in the equation is generated by a random number. Compared with the prior art, the invention is simpler and more flexible. For the security, the present invention cannot be cracked by present existing technologies. Unless the value n is cracked or the value i is found from the public key, the private key can be found. However, it involves the same difficulty of finding the value i or cracking the value n. The invention performs a computation once only and extends the length of the keys to improve the level of security.

While the invention has been described by means of specific embodiments, numerous modifications and variations could be made thereto by those skilled in the art without departing from the scope and spirit of the invention set forth in the claims.

What is claimed is:

1. An asymmetric encryption/decryption method, comprising the steps of:
(i) providing a plaintext (M) and a modulus (n);
(ii) selecting a public key (e) and a private key (d) from the modulus (n), and e×d mod n=1;
(iii) generating a ciphertext (C) by M×e mod n=C; and
(iv) recovering the plaintext by C×d mod n=M

2. The method of claim 1, wherein the public key and the private key are calculated by mⁱ×^{n+1/}ₘⁱ mod n=1, n+1 mod m=0, i,m>0.

3. The method of claim 2, wherein the length i represented by a linear bit matrix has a length not greater than the length of the modulus.

4. The method of claim 2, wherein the value i presented by a linear bit matrix includes a plurality of ones.

5. The method of claim 2, wherein the value i is generated by a random number generator.

6. The method of claim 2, wherein the public key and the private key are e=2ⁱ mod n, d=½ⁱ mod n, ½≡n+ 1/2.

7. The method of claim 2, wherein the public key and the private key are e=½ⁱ mod n, d=2ⁱ mod n, ½≡n+ 1/2.

8. The method of claim 6, wherein the public key and the private key are e=eⁱ mod n, d=dⁱ mod n; t≧0.

9. The method of claim 7, wherein the public key and the private key are e=eⁱ mod n, d=dⁱ mod n; t≧0.

10. The method of claim 8, wherein the public key and the private key are changed synchronously.

11. The method of claim 9, wherein the public key and the private key are changed synchronously.

12. The method of claim 1, wherein the public key is not equal to the private key.

13. The method of claim 1, wherein the plaintext is smaller than the modulus and presented by a linear bit matrix, and the plaintext includes a plurality of ones.

14. The method of claim 1, wherein the plaintext represented by a linear bit matrix has a length smaller than the length of the public key.

15. The method of claim 1, wherein the plaintext represented by a linear bit matrix has a length smaller than the length of the private key.

16. The method of claim 1, wherein the modulus is a product of a plurality of prime numbers.

17. The method of claim 16, wherein the modulus represented by a linear bit matrix is a product of two prime numbers, and the two prime numbers have an equal length.

18. The method of claim 1, wherein the plaintext is a stream plaintext, and the ciphertext is a stream ciphertext.

19. The method of claim 18, wherein the stream plaintext represented by a linear bit matrix has a reading length in a stream smaller than the length of the modulus.

20. The method of claim 18, wherein the stream ciphertext represented by a linear bit matrix has an encryption length in a stream not smaller than the length of the modulus.
